(19) United States
(12) Patent Application Publication
(10) Pub. No.: US 2018/0329546 A1
(43) Pub. Date: Nov. 15, 2018

(54) TOUCH DISPLAY PANEL, A DRIVING METHOD THEREOF, AND TOUCH DISPLAY DEVICE

(71) Applicants: BOE TECHNOLOGY GROUP CO., LTD., Chongqing (CN); CHONGQING BOE OPTOELECTRONICS TECHNOLOGY CO., LTD., Beijing (CN)

(72) Inventors: Qian QIAN, Beijing (CN); Heecheol KIM, Beijing (CN); Zhi ZHANG, Beijing (CN); Zhihui WANG, Beijing (CN); Shuai CHEN, Beijing (CN); Taoliang TANG, Beijing (CN); Lei CHEN, Beijing (CN); Gang CHEN, Beijing (CN)

(73) Assignees: BOE TECHNOLOGY GROUP CO., LTD., Chongqing (CN); CHONGQING BOE OPTOELECTRONICS TECHNOLOGY CO., LTD., Beijing (CN)

(21) Appl. No.: 15/512,594

(22) PCT Filed: Jan. 18, 2016
(86) PCT No.: PCT/CN2016/071173

§ 371 Date: Mar. 20, 2017

(30) Foreign Application Priority Data
Aug. 24, 2015 (CN) 201510522132.5

(51) Int. Cl. G06F 3/041; G06F 3/044; G09G 3/20

(52) U.S. Cl. CPC G06F 3/0412; G06F 3/044; G09G 2310/08; G09G 3/2003; G02F 2201/121; G06F 3/0416

(57) ABSTRACT

A touch display panel, a driving method thereof, and a touch display device are provided. The touch display panel includes a timing controller, a first substrate and a second substrate arranged opposite to the first substrate. The first substrate includes a base substrate and common electrodes arranged on the base substrate. The first substrate further includes a touch switching unit connected to the timing controller via a touch control line and configured to control, within a touch time period, the common electrodes to receive a touch driving signal under the control of a touch control signal from the touch control line, and a display switching unit connected to the timing controller via a display control line and configured to control, within a display time period, the common electrodes to receive a common electrode voltage signal under the control of a display control signal from the display control line.

### CROSS-REFERENCE TO RELATED APPLICATION

The present application claims a priority of the Chinese patent application No. 201510522132.5 filed on Aug. 24, 2015, which is incorporated herein by reference in its entirety.

### TECHNICAL FIELD

The present disclosure relates to the field of touch display technology, in particular to a touch display panel, a driving method thereof and a touch display device.

### BACKGROUND

For an Advanced Matrix Pad (AMP, a self-capacitive touch panel with a touch sensing electrode also serving as a touch driving electrode)-based touch panel, a wire made of metal having a low resistance rather than indium tin oxide (ITO) is used, so it is merely necessary to add a metal mask for the metal wire on an array substrate, and common electrodes arranged separate from each other are multiplexed as self-capacitive touch electrodes in a time-division manner.

However, as shown in FIG. 1, for the conventional AMP-based touch panel, in the case that the common electrodes are multiplexed as the touch electrodes in a time-division manner, it is necessary to further provide a time-division multiplexing switch 11 and a time-division multiplexing controller 12. A plurality of block-like common electrodes arranged in an array form on a base substrate 10 may be connected to the time-division multiplexing controller 12 via the time-division multiplexing switch 11, resulting in a large number of data bonding pins between the common electrodes and the time-division multiplexing switch 11. As a result, the production cost may increase and an excessive space of the touch panel may be occupied, and thereby the actual application thereof may be difficult.

### SUMMARY

A main object of the present disclosure is to provide a touch display panel, a driving method thereof, and a touch display device, so as to reduce the production cost and prevent an excessive space of the touch panel from being occupied due to a large number of data bonding pins between the common electrodes and the time-division multiplexing switch.

In one aspect, the present disclosure provides in some embodiments a touch display panel, including a timing controller, a first substrate and a second substrate arranged opposite to the first substrate. The first substrate includes a base substrate and common electrodes arranged on the base substrate. The first substrate further includes: a touch switching unit connected to the timing controller via a touch control line and configured to control, within a touch time period, the common electrodes to receive a touch driving signal under the control of a touch control signal from the touch control line; and a display switching unit connected to the timing controller via a display control line and configured to control, within a display time period, the common electrodes to receive a common electrode voltage signal under the control of a display control signal from the display control line.

In a possible embodiment of the present disclosure, in the case that the first substrate includes the common electrodes arranged in M rows and N columns, the touch switching unit includes M*N touch switching modules. Each touch switching module is connected to one of the common electrodes and configured to control, within the touch time period, the one of the common electrodes to receive the touch driving signal under the control of the touch control signal. M and N are each a positive integer greater than 1.

In a possible embodiment of the present disclosure, the touch switching module includes a touch switching transistor, a gate electrode of which is connected to the touch control line, a first electrode of which is configured to receive the touch driving signal, and a second electrode of which is connected to one of the common electrodes.

In a possible embodiment of the present disclosure, the display switching unit includes a display switching transistor, a gate electrode of which is connected to the display control line, a first electrode of which is configured to receive the common electrode voltage signal, and a second electrode of which is connected to the common electrodes.

In a possible embodiment of the present disclosure, the touch switching transistor and the display switching transistor are both N-type transistors. In the case that the touch control signal is at a high level and the display control signal is at a low level, the touch switching transistor is turned on, and in the case that the touch control signal is at a low level and the display control signal is at a high level, the display switching transistor is turned on.

In a possible embodiment of the present disclosure, the touch switching transistor and the display switching transistor are both P-type transistors. In the case that the touch control signal is at a low level and the display control signal is at a high level, the touch switching transistor is turned on, and in the case that the touch control signal is at a high level and the display control signal is at a low level, the display switching transistor is turned on.

In a possible embodiment of the present disclosure, the touch driving signal is applied to all the common electrodes simultaneously within the touch time period.

In a possible embodiment of the present disclosure, the touch driving signal is applied to the M rows of common electrodes row by row within the touch time period.

In a possible embodiment of the present disclosure, the touch driving signal is applied to the N columns of common electrodes column by column within the touch time period.

In a possible embodiment of the present disclosure, within the touch time period, the M rows of common electrodes are scanned row by row, and then the N columns of common electrodes are scanned column by column.

In a possible embodiment of the present disclosure, the touch switching unit includes M touch switching modules. The common electrodes in each row are connected to one of the touch switching modules, and the M touch switching modules are turned on sequentially.

In a possible embodiment of the present disclosure, the touch switching unit includes N touch switching modules. The common electrodes in each column are connected to one of the touch switching modules, and the N touch switching modules are turned on sequentially.

In a possible embodiment of the present disclosure, the first substrate is an array substrate and the second substrate is a color filter substrate.

In a possible embodiment of the present disclosure, the first substrate is a color filter substrate and the second substrate is an array substrate.

In a possible embodiment, the timing controller further includes a red-subpixel control line, a green-subpixel control line and a blue-subpixel control line. The first substrate further includes a red-subpixel switching transistor, a green-subpixel switching transistor and a blue-subpixel switching transistor. The touch switching transistor, the red-subpixel switching transistor, the green-subpixel switching transistor and the blue-subpixel switching transistor are connected to a source driver via an identical data line. A gate electrode of the red-subpixel switching transistor is connected to the red-subpixel control line, a first electrode thereof is connected to the source driver, and a second electrode thereof is connected to a red subpixel. The red-subpixel switching transistor is configured to control the red subpixel to receive or not receive a red-subpixel data signal from the source driver under the control of a red-subpixel selection signal from the red-subpixel control line. A gate electrode of the green-subpixel switching transistor is connected to a green-subpixel control line, a first electrode thereof is connected to the source driver, and a second electrode thereof is connected to a green subpixel. The green-subpixel switching transistor is configured to control the green subpixel to receive or not receive a green-subpixel data signal from the source driver under the control of a green-subpixel selection signal from the green-subpixel control line. A gate electrode of the blue-subpixel switching transistor is connected to the blue-subpixel control line, a first electrode thereof is connected to the source driver, and a second electrode thereof is connected to a blue subpixel. The blue-subpixel switching transistor is configured to control the blue subpixel to receive or not receive a blue-subpixel data signal from the source driver under the control of a blue-subpixel selection signal from the blue-subpixel control line.

In another aspect, the present disclosure provides in some embodiments a method for driving the above-mentioned touch display panel, including steps of: within a touch time period, controlling, by a touch switching unit, common electrodes included in a first substrate to receive a touch driving signal under the control of a touch control signal from a touch control line; and within a display time period, controlling, by a display switching unit, the common electrodes to receive a common electrode voltage signal under the control of a display control signal from a display control line.

In a possible embodiment of the present disclosure, in the case that the common electrodes included in the first substrate are arranged in M rows and N columns, the step of, within the touch time period, controlling, by the touch switching unit, the common electrodes to receive the touch driving signal under the control of the touch control signal from the touch control line includes: within the touch time period, applying the touch driving signal to all the common electrodes simultaneously; or within the touch time period, applying the touch driving signal to the M rows of common electrodes row by row; or within the touch time period, applying the touch driving signal to the N columns of common electrodes column by column; or within the touch time period, scanning the M rows of common electrodes row by row and then scanning the N columns of common electrodes column by column. M and N are each a positive integer greater than 1.

In yet another aspect, the present disclosure provides in some embodiments a touch display device including the above-mentioned touch display panel.

According to the touch display panel, the driving method thereof and the touch display device in the embodiments of the present disclosure, the touch switching unit and the display switching unit may be controlled by the touch control line and the display control line connected to the timing controller, respectively, so as to enable the common electrodes to receive the touch driving signal and the common electrode voltage signal in a time-division manner, thereby to switch between the touch time period and the display time period. As a result, it is able to replace the time-division multiplexing controller and the time-division multiplexing switch in the related art with the touch switching unit and the display switching unit, and reduce the number of the data bonding pins, thereby to save the space and reduce the production cost.

### BRIEF DESCRIPTION OF THE DRAWINGS

FIG. 1 is a schematic view showing a conventional touch panel;

FIG. 2 is a schematic view showing a touch display panel according to at least one embodiment of the present disclosure;

FIG. 3 is another schematic view showing the touch display panel according to at least one embodiment of the present disclosure;

FIG. 4 is yet another schematic view showing the touch display panel according to at least one embodiment of the present disclosure; and

FIG. 5 is a flow chart of a method for driving the touch display panel according to at least one embodiment of the present disclosure.

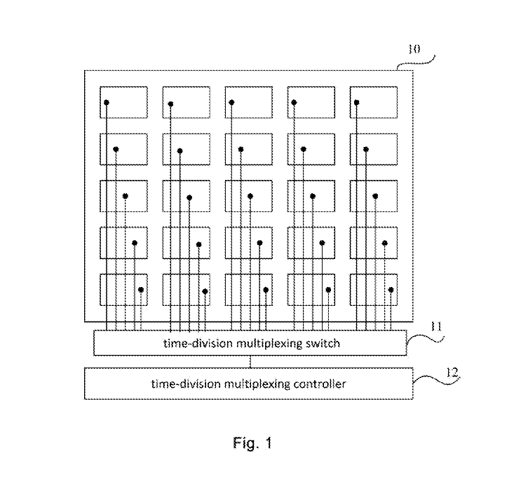

### DETAILED DESCRIPTION OF THE EMBODIMENTS

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

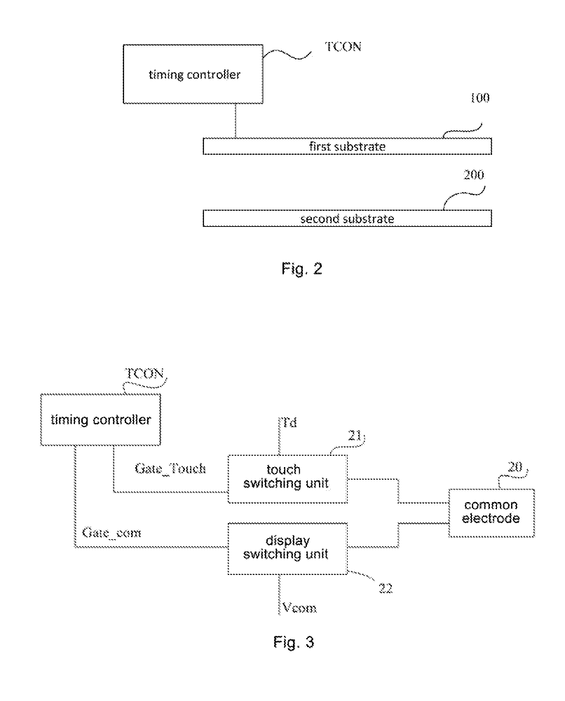

As shown in FIG. 2, the present disclosure provides in some embodiments a touch display panel, including a timing controller TCON, a first substrate 100 and a second substrate 200 arranged opposite to the first substrate 100. As shown in FIG. 3, the first substrate 100 includes a base substrate (not shown) and common electrodes 20 arranged on the base substrate. The first substrate 100 further includes: a touch switching unit 21 connected to the timing controller TCON via a touch control line Gate_Touch and configured to control, within a touch time period, the common electrodes 20 to receive a touch driving signal Td under the control of a touch control signal from the touch control line Gate_Touch; and a display switching unit 22 connected to the timing controller TCON via a display control line Gate_com and configured to control, within a display time period, the common electrodes to receive a common electrode voltage signal Vcom under the control of a display control signal from the display control line Gate_com.

During the actual application, the timing controller TCON may be arranged outside the first substrate.

To be specific, the first substrate may be an array substrate or a color filter substrate. When the first substrate is an array substrate, the second substrate may be a color filter substrate, and when the first substrate is a color filter substrate, the second substrate may be an array substrate.

According to the embodiments of the present disclosure, the touch switching unit 21 and the display switching unit 22 may be controlled by the touch control line Gate_Touch and the display control line Gate_com that are connected to the timing controller TCON, respectively, so as to enable the common electrodes to receive the touch driving signal and the common electrode voltage signal in a time-division manner, thereby to switch between the touch time period and the display time period. As a result, it is able to replace a time-division multiplexing controller and a time-division multiplexing switching in the related art with the touch switching unit 21 and the display switching unit 22, and reduce the number of data bonding pins, thereby to save the space and reduce the production cost.

In a possible embodiment of the present disclosure, when the first substrate includes the common electrodes arranged in an array form of M rows and N columns, the touch switching unit includes M*N touch switching modules. Each touch switching module is connected to one of the common electrodes and configured to control, within the touch time period, the common electrode to receive the touch driving signal under the control of the touch control signal. M and N are each a positive integer greater than 1. In other words, in the case that the common electrodes of the first substrate are arranged in an array form of a plurality of rows and a plurality of columns, one touch switching module may be connected between each common electrode and the touch control line, so as to control the application of the touch driving signal to the common electrode within the touch time period.

During the actual application, within the touch time period, in the case that the common electrodes of the first substrate are arranged in an array form of M rows and N columns (M and N are each a positive integer greater than 1), the touch driving signal may be applied to all the common electrodes simultaneously, or to the M rows of common electrodes row by row, or to the N columns of common electrodes column by column, or the M rows of common electrodes in may be scanned row by row and then the N columns of common electrodes may be scanned column by column. Any of the above-mentioned touch driving and scanning modes may be selected, as long as a touch position is accurately acquired in accordance with a touch sensing signal. The above touch driving modes and the self-capacitive touch sensing procedures thereof are known in the art, and thus will not be particularly defined herein.

To be specific, in the case that the touch driving signal is applied to the M rows of common electrodes row by row, the touch switching unit may include M touch switching modules. Each row of common electrodes may be connected to one of the touch switching modules, and the M touch switching modules may be turned on sequentially so as to apply the touch driving signal to the M rows of common electrodes row by row. In the case that the touch driving signal is applied to the N columns of common electrodes column by column, the touch switching unit may include N touch switching modules. Each column of common electrodes may be connected to one of the touch switching modules, and the N touch switching modules may be turned on sequentially so as to apply the touch driving signal to the N columns of common electrodes column by column.

In a possible embodiment of the present disclosure, the touch switching module includes a touch switching transistor, a gate electrode of which is connected to the touch control line, a first electrode of which is configured to receive the touch driving signal, and a second electrode of which is connected to one of the common electrodes.

To be specific, the display switching unit includes a display switching transistor, a gate electrode of which is connected to the display control line, a first electrode of which is configured to receive the common electrode voltage signal, and a second electrode of which is connected to the common electrodes.

During the actual application, in the case that the common electrodes of the first substrate are arranged in an array form of a plurality of rows and a plurality of columns, different from the situation where one touch switching transistor is connected between each common electrode and the touch control line, the display switching unit may merely include one display switching transistor. All the common electrodes arranged in a plurality of rows and a plurality of columns may be connected to the second end of the display switching transistor, and within the display time period, the common electrode voltage signal may be applied to all the common electrodes simultaneously.

The touch display panel will be described hereinafter in conjunction with a specific embodiment.

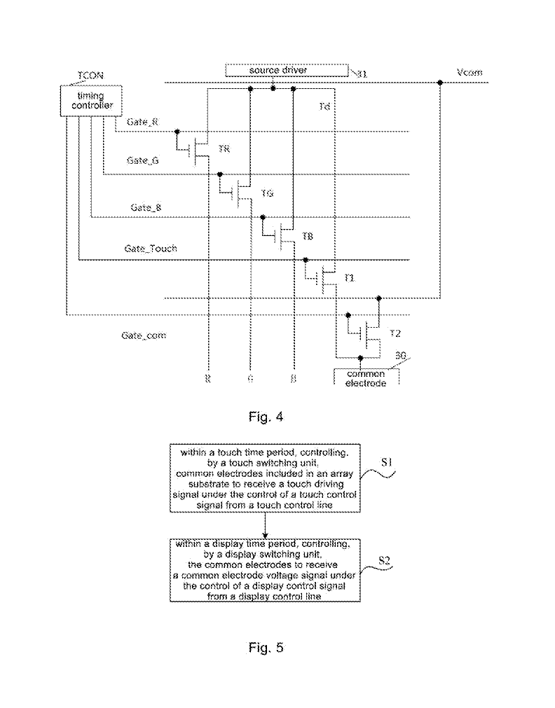

As shown in FIG. 2, the touch display panel includes the timing controller TCON, the first substrate, and the second substrate arranged opposite to the first substrate. As shown in FIG. 4, the first substrate includes the base substrate (not shown) and common electrodes 30 arranged on the base substrate. The first substrate further includes a touch switching transistor T1 and a display switching transistor T2. A gate electrode of the touch switching transistor T1 is connected to the touch control line Gate_Touch connected to the timing controller TCON, a first electrode thereof is connected to a source driver 31, and a second electrode thereof is connected to the common electrodes 30. The touch switching transistor T1 is configured to control, within the touch time period, the common electrodes 30 to receive the touch driving signal Td from the source driver 31 under the control of the touch control signal from the touch control line Gate_Touch. A gate electrode of the display switching transistor T2 is connected to the display control line Gate_com connected to the timing controller TCON, a first electrode thereof is connected to a common electrode line for outputting the common electrode voltage signal Vcom, and a second electrode thereof is connected to the common electrodes 30. The display switching transistor T2 is configured to control, within the display time period, the common electrodes 30 to receive the common electrode voltage signal Vcom under the control of the display control signal from the display control line Gate_com.

It should be appreciated that, the touch driving signal is not necessarily inputted by the source driver, and in some other embodiments of the present disclosure, it may also be inputted by a dedicated touch chip, the touch chip may also be integrated into the source driver.

In FIG. 4, T1 and T2 are each an N-type transistor. In the case that the touch control signal is at a high level and the display control signal is at a low level, the common electrodes may receive the touch driving signal Td, and a touch display panel including the first substrate may be switched into a touch state so as to achieve a touch function. In the case that the touch control signal is at a low level and the display control signal is at a high level, the common electrodes may receive the common electrode voltage signal Vcom, and the touch display panel may be switched into a display state so as to achieve a display function.

During the actual application, T1 and T2 may also be P-type transistors. In the case that the touch control signal is at a low level and the display control signal is at a high level, the common electrodes may receive the touch driving signal Td, and the touch display panel including the first substrate may be switched into the touch state so as to achieve the touch function. In the case that the touch control signal is at a high level and the display control signal is at a low level, the common electrodes may receive the common electrode voltage signal Vcom, and the touch display panel may be switched into the display state so as to achieve the display function.

In the embodiment as shown in FIG. 4, through Gate_Touch, Gate_com, T1 and T2, the common electrodes may be multiplexed in a time-division manner so as to achieve the touch function and the display function respectively, and both T1 and T2 may be arranged on the first substrate. Through the replacement of the time-division multiplexing switch and the time-division multiplexing controller that are not arranged on the first substrate with the transistors arranged on the first substrate, it is able to reduce the number of the data bonding pins as well as the production cost.

As shown in FIG. 4, the timing controller further includes a red-subpixel control line Gate_R, a green-subpixel control line Gate_G and a blue-subpixel control line Gate_B. The first substrate further includes a red-subpixel switching transistor TR, a green-subpixel switching transistor TG and a blue-subpixel switching transistor TB. The touch switching transistor T1, the red-subpixel switching transistor TR, the green-subpixel switching transistor TG and the blue-subpixel switching transistor TB are connected to the source driver 31 via an identical data line. A gate electrode of the red-subpixel switching transistor TR is connected to the red-subpixel control line Gate_R, a first electrode thereof is connected to the source driver 31, and a second electrode thereof is connected to a red subpixel R. The red-subpixel switching transistor TR is configured to control the red subpixel R to receive or not receive a red-subpixel data signal from the source driver 31 under the control of a red-subpixel selection signal from the red-subpixel control line Gate_R. A gate electrode of the green-subpixel switching transistor TG is connected to a green-subpixel control line Gate_G, a first electrode thereof is connected to the source driver 31, and a second electrode thereof is connected to a green subpixel G. The green-subpixel switching transistor TG is configured to control the green subpixel G to receive or not receive a green-subpixel data signal from the source driver 31 under the control of a green-subpixel selection signal from the green-subpixel control line Gate_G. A gate electrode of the blue-subpixel switching transistor TB is connected to the blue-subpixel control line Gate_B, a first electrode thereof is connected to the source driver 31, and a second electrode thereof is connected to a blue subpixel B. The blue-subpixel switching transistor TB is configured to control the blue subpixel B to receive or not receive a blue-subpixel data signal from the source driver 31 under the control of a blue-subpixel selection signal from the blue-subpixel control line Gate_B.

In FIG. 4, the touch switching transistor T1, the red-subpixel switching transistor TR, the green-subpixel transistor TG and the blue-subpixel transistor TB are connected to the source driver 31 via an identical data line, i.e., the source driver 31 is controlled through a multiplexing (MUX) technique so as to transmit a corresponding data signal or a corresponding touch driving signal to the respective data lines and the respective common electrodes. The MUX-based touch display panel is of a simple structure, so it is able to remarkably reduce a size of the touch display panel and facilitate the mass production thereof, thereby to reduce the production cost.

In the embodiment as shown in FIG. 4, on the basis of the MUX technique, the touch control line Gate_Touch and the display control line Gate_com connected to the timing controller TCON are provided to control the touch switching transistor and the display switching transistor respectively, so as to enable the common electrodes to receive the touch driving signal and the common electrode voltage signal in a time-division manner, thereby to switch between the touch time period and the display time period.

In the embodiments of the present disclosure, all the transistors may be thin film transistors (TFTs), field effect transistors (FETs) or any other elements having a similar characteristic. In order to differentiate the two electrodes other than the gate electrode, the first electrode may be a source electrode or a drain electrode, and the second electrode may be a drain electrode or a source electrode. In addition, depending on their characteristics, the transistors may be N-type transistors or P-type transistors. For the driver circuit in the embodiments of the present disclosure, the above description is given by taking the N-type transistors as an example. It should be appreciated that, the P-type transistors may also be used, which also fall within the scope of the present disclosure.

As shown in FIG. 5, the present disclosure further provides in some embodiments a method for driving the above-mentioned touch display panel, including: Step S1 of, within the touch time period, controlling, by the touch switching unit, the common electrodes included in the first substrate to receive the touch driving signal under the control of the touch control signal from the touch control line; and Step S2 of, within the display time period, controlling, by the display switching unit, the common electrodes to receive the common electrode voltage signal under the control of the display control signal from the display control line.

In a possible embodiment of the present disclosure, in the case that the common electrodes of the first substrate are arranged in an array form of M rows and N columns, Step S1 may include: within the touch time period, applying the touch driving signal to all the common electrodes simultaneously; or within the touch time period, applying the touch driving signal to the M rows of common electrodes row by row; or within the touch time period, applying the touch driving signal to the N columns of common electrodes column by column; or within the touch time period, scanning the M rows of common electrodes row by row and then scanning the N column of common electrodes column by column. M and N are each a positive integer greater than 1.

In the embodiments of the present disclosure, the touch display panel includes the timing controller and the above mentioned first substrate connected to each other.

The present disclosure further provides in some embodiments a touch display device including the above-mentioned touch display panel. The touch display device may be any product or member having a display function and a touch function, such as a liquid crystal panel, an electronic paper, an organic light-emitting diode (OLED) panel, a liquid crystal television, a liquid crystal display, a digital photo frame, a mobile phone or a flat-panel computer.

The above are merely the preferred embodiments of the present disclosure. Obviously, a person skilled in the art may make further modifications and improvements without departing from the spirit of the present disclosure, and these modifications and improvements shall also fall within the scope of the present disclosure.

1. A touch display panel, comprising a timing controller, a first substrate and a second substrate arranged opposite to the first substrate, the first substrate comprising a base substrate and common electrodes arranged on the base substrate,
wherein the first substrate further comprises: a touch switching unit connected to the timing controller via a touch control line and configured to control, within a touch time period, the common electrodes to receive a touch driving signal under the control of a touch control signal from the touch control line; and a display switching unit connected to the timing controller via a display control line and configured to control, within a display time period, the common electrodes to receive a common electrode voltage signal under the control of a display control signal from the display control line.

2. The touch display panel according to claim 1, wherein the first substrate comprises the common electrodes arranged in M rows and N columns, and the touch switching unit comprises M*N touch switching modules;
each touch switching module is connected to one of the common electrodes and configured to control, within the touch time period, the one of the common electrodes to receive the touch driving signal under the control of the touch control signal; and
M and N are each a positive integer greater than 1.

3. The touch display panel according to claim 2, wherein the touch switching module comprises a touch switching transistor, a gate electrode of the touch switching transistor is connected to the touch control line, a first electrode of the touch switching transistor is configured to receive the touch driving signal, and a second electrode of the touch switching transistor is connected to one of the common electrodes.

4. The touch display panel according to claim 1, wherein the display switching unit comprises a display switching transistor, a gate electrode of the display switching transistor is connected to the display control line, a first electrode of the display switching transistor is configured to receive the common electrode voltage signal, and a second electrode of the display switching transistor is connected to the common electrodes.

5. The touch display panel according to claim 4, wherein the touch switching transistor and the display switching transistor are both N-type transistors;
when the touch control signal is at a high level and the display control signal is at a low level, the touch switching transistor is turned on; and
when the touch control signal is at a low level and the display control signal is at a high level, the display switching transistor is turned on.

6. The touch display panel according to claim 4, wherein the touch switching transistor and the display switching transistor are both P-type transistors;
when the touch control signal is at a low level and the display control signal is at a high level, the touch switching transistor is turned on; and
when the touch control signal is at a high level and the display control signal is at a low level, the display switching transistor is turned on.

7. The touch display panel according to claim 2, wherein the touch driving signal is applied to all the common electrodes simultaneously within the touch time period.

8. The touch display panel according to claim 2, wherein the touch driving signal is applied to the M rows of common electrodes row by row within the touch time period.

9. The touch display panel according to claim 2, wherein the touch driving signal is applied to the N columns of common electrodes column by column within the touch time period.

10. The touch display panel according to claim 2, wherein within the touch time period, the M rows of common electrodes are scanned row by row, and then the N columns of common electrodes are scanned column by column.

11. The touch display panel according to claim 8, wherein the touch switching unit comprises M touch switching modules, the common electrodes in each row are connected to one of the touch switching modules, and the M touch switching modules are turned on sequentially.

12. The touch display panel according to claim 9, wherein the touch switching unit comprises N touch switching modules, the common electrodes in each column are connected to one of the touch switching modules, and the N touch switching modules are turned on sequentially.

13. The touch display panel according to claim 1, wherein the first substrate is an array substrate and the second substrate is a color filter substrate.

14. The touch display panel according to claim 1, wherein the first substrate is a color filter substrate and the second substrate is an array substrate.

15. The touch display panel according to claim 4, wherein the timing controller further comprises a red-subpixel control line, a green-subpixel control line and a blue-subpixel control line;
the first substrate further comprises a red-subpixel switching transistor, a green-subpixel switching transistor and a blue-subpixel switching transistor;
the touch switching transistor, the red-subpixel switching transistor, the green-subpixel switching transistor and the blue-subpixel switching transistor are connected to a source driver via an identical data line;
a gate electrode of the red-subpixel switching transistor is connected to the red-subpixel control line, a first electrode of the red-subpixel switching transistor is connected to the source driver, and a second electrode of the red-subpixel switching transistor is connected to a red subpixel; the red-subpixel switching transistor is configured to control the red subpixel to receive or not receive a red-subpixel data signal from the source driver under the control of a red-subpixel selection signal from the red-subpixel control line;
a gate electrode of the green-subpixel switching transistor is connected to a green-subpixel control line, a first electrode of the green-subpixel switching transistor is connected to the source driver, and a second electrode of the green-subpixel switching transistor is connected to a green subpixel;
the green-subpixel switching transistor is configured to control the green subpixel to receive or not receive a green-subpixel data signal from the source driver under the control of a green-subpixel selection signal from the green-subpixel control line;
a gate electrode of the blue-subpixel switching transistor is connected to the blue-subpixel control line, a first electrode of the blue-subpixel switching transistor is connected to the source driver, and a second electrode of the blue-subpixel switching transistor is connected to a blue subpixel; and
the blue-subpixel switching transistor is configured to control the blue subpixel to receive or not receive a blue-subpixel data signal from the source driver under the control of a blue-subpixel selection signal from the blue-subpixel control line.

16. A method for driving the touch display panel according to claim 1, comprising steps of:
within a touch time period, controlling, by a touch switching unit, common electrodes included in a first substrate to receive a touch driving signal under the control of a touch control signal from a touch control line; and
within a display time period, controlling, by a display switching unit, the common electrodes to receive a common electrode voltage signal under the control of a display control signal from a display control line.

17. The method according to claim 16, wherein the common electrodes included in the first substrate are arranged in M rows and N columns, the step of, within the touch time period, controlling, by the touch switching unit, the common electrodes included in the first substrate to receive the touch driving signal under the control of the touch control signal from the touch control line comprises:
within the touch time period, applying the touch driving signal to all the common electrodes simultaneously; or
within the touch time period, applying the touch driving signal to the M rows of common electrodes row by row; or
within the touch time period, applying the touch driving signal to the N columns of common electrodes column by column; or
within the touch time period, scanning the M rows of common electrodes row by row and then scanning the N columns of common electrodes column by column,
wherein M and N are each a positive integer greater than 1.

18. A touch display device, comprising the touch display panel according to claim 1.
